(19) United States
(12) Patent Application Publication
(10) Pub. No.: US 2024/0413943 A1
(43) Pub. Date: Dec. 12, 2024

(54) RESOURCE BLOCK (RB) SET CONFIGURATION FOR FREQUENCY DOMAIN RESOURCES

(71) Applicant: Telefonaktiebolaget LM Ericsson (publ), Stockholm (SE)

(72) Inventors: Magnus ÅSTRÖM, Lund (SE); Boris DORTSCHY, Vendelsö (SE); Lei BAO, Göteborg (SE)

(21) Appl. No.: 18/706,950

(22) PCT Filed: Oct. 27, 2022
(86) PCT No.: PCT/EP2022/080105

§ 371 Date: May 2, 2024

Related U.S. Application Data
(60) Provisional application No. 63/275,280, filed on Nov. 3, 2021.

(51) Int. Cl. H04L 5/00

(52) U.S. Cl. CPC H04L 5/0044; H04L 5/0005

(57) ABSTRACT

A method, system and apparatus for resource block (RB) set configuration in an integrated access and backhaul (IAB) network for frequency domain resources are disclosed. According to one aspect, a method in an IAB donor node in communication with a first IAB node includes receiving a resource multiplexing capability from the first IAB node. The method includes determining a resource block, RB, set configuration based at least in part on the resource multiplexing capability. The method further includes determining a DU resource configuration for the first IAB node based at least in part on the RB set configuration; and transmitting the DU resource configuration to the first IAB node.

### TECHNICAL FIELD

The present disclosure relates to wireless communications, and in particular, to resource block (RB) set configuration in an integrated access and backhaul (IAB) network for frequency domain resources.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

### Integrated Access and Backhaul Overview

Densification via the deployment of increasing numbers of base stations (macro or micro base stations) is one of the mechanisms that can be employed to satisfy the ever-increasing demand for more bandwidth and capacity in mobile networks. Due to the availability of more spectrum in the millimeter wave (mmW) band, deploying small cells that operate in this band is an attractive deployment option for these purposes. However, deploying fiber to the small cells, which is the usual way in which small cells are deployed, can be very expensive and impractical. Thus, employing a wireless link for connecting the small cells to the operator's network is a cheaper and practical alternative with more flexibility and shorter time-to-market.

One such solution is an Integrated Access and Backhaul (IAB) network, where the operator can utilize part of the radio resources for the backhaul link.

FIG. 1 shows an IAB deployment that supports multiple hops. The IAB donor node (IAB donor 2) has a wired connection to the core network and the IAB nodes 3 and 4 are wirelessly connected using NR to the IAB donor 2, either directly or indirectly via another IAB node. The connection between IAB donor node 2 and WDs is called an access link, whereas the connection between two IAB nodes 3 and 4 or between an IAB donor 2 and an IAB node 3 is called a backhaul link.

FIG. 2 shows a parent node 6 connected by a backhaul link to an IAB node 7 which is connected by another backhaul link to a child node 8. The parent node 6 is upstream from the IAB child node 8, and the child not 8 is downstream from the IAB node 7. An adjacent downstream node which is further away from the IAB donor node of an IAB node is referred to as a child node of the IAB-node. The backhaul link between the parent node and the IAB-node is referred to as parent (backhaul) link, whereas the backhaul link between the IAB-node and the child node is referred to as child (backhaul) link.

### IAB Architecture

One difference between the IAB architecture and the 3GPP Technical Release 10 (3GPP Rel-10) LTE relay (besides lower layer differences) is that the IAB architecture adopts the Central-Unit/Distributed-Unit (CU/DU) split of gNBs. In such a split, time-critical functionalities are realized in the DU closer to the radio, whereas the less time-critical functionalities are pooled in the CU with the opportunity for centralization. Based on this architecture, an IAB-donor contains both CU and DU functions. In particular, it contains all CU functions of the IAB-nodes under the same IAB-donor. Each IAB-node then hosts the DU function(s) of a gNB. In order to be able to transmit and receive wireless signals to and from the upstream IAB-node or IAB-donor, each IAB-node has a mobile termination (MT), a logical unit providing a necessary set of WD-like functions. Via the DU, the IAB-node establishes a radio link control (RLC)-channel to WDs and/or to MTs of the connected IAB-node(s). Via the MT, the IAB-node establishes the backhaul radio interface towards the serving IAB-node or IAB-donor. FIG. 3 shows a reference diagram for a two-hop chain of IAB-nodes under an IAB-donor.

### Resource Configuration

### Time-Domain Resource Coordination

In cases of in-band operation, an IAB-node is typically subject to the half-duplex constraint, which means that an IAB-node can only be in either a transmission mode or a reception mode at one time. A 3GPP Rel-16-compliant IAB mainly considers the time-division multiplexing (TDM) case where the MT and DU resources of the same IAB-node are separated in time. Based on this consideration, the following resource types have been defined for IAB MT and DU, respectively.

From an IAB-node MT point-of-view, as in 3GPP Rel-15, the following time-domain resources can be indicated for the parent link:
Downlink (DL) time resource;
Uplink (UL) time resource; and/or
Flexible (F) time resource.

From an IAB-node DU point-of-view, the child link has the following types of time resources:
DL time resource;
UL time resource;
F time resource; and/or
Not-available (NA) time resources (resources not to be used for communication on the DU child links).

Each of the downlink, uplink and flexible time-resource types of the DU child link can belong to one of two categories:
Hard (H): The corresponding time resource is always available for the DU child link;
Soft(S): The availability of the corresponding time resource for the DU child link is explicitly and/or implicitly controlled by the parent node.

The IAB DU resources are configured per cell, and the H/S/NA attributes for the DU resource configuration are explicitly indicated per-resource type (D/U/F) in each slot. As a result, the semi-static time-domain resources of the DU part can be of seven types in total: Downlink-Hard (DL-H), Downlink-Soft (DL-S), Uplink-Hard (UL-H), Uplink-Soft (UL-S), Flexible-Hard (F-H), Flexible-Soft (F-S), and Not-Available (NA). The coordination relationships between MT and DU resources are listed in Table 1.

TABLE 1
Coordination between MT and DU resources of an IAB-node.

| | | MT configuration | | |
|---|---|---|---|---|
| | | DL | UL | Flexible |
| DU | DL-H | DU: can transmit on | DU: can transmit on | DU: can transmit on |
| configuration | | DL unconditionally; | DL unconditionally; | DL unconditionally; |
| | | MT: not available. | MT: not available. | MT: not available. |
| | DL-S | DU: can transmit | DU: can transmit | DU: can transmit |
| | | conditionally; | conditionally; | conditionally; |
| | | MT: available on | MT: available on | MT: available on DL |
| | | DL. | UL. | & UL. |
| | UL-H | DU: can schedule | DU: can schedule | DU: can schedule |
| | | UL unconditionally; | UL unconditionally; | UL unconditionally; |
| | | MT: not available. | MT: not available. | MT: not available. |
| | UL-S | DU: can schedule | DU: can schedule | DU: can schedule |
| | | UL conditionally; | UL conditionally; | UL conditionally; |
| | | MT: available on | MT: available on | MT: available on DL |
| | | DL. | UL. | & UL. |
| | F-H | DU: can transmit on | DU: can transmit on | DU: can transmit on |
| | | DL or schedule UL | DL or schedule UL | DL or schedule UL |
| | | unconditionally; | unconditionally; | unconditionally; |
| | | MT: not available. | MT: not available. | MT: not available. |
| | F-S | DU: can transmit on | DU: can transmit on | DU: can transmit on |
| | | DL or schedule UL | DL or schedule UL | DL or schedule UL |
| | | conditionally; | conditionally; | conditionally; |
| | | MT: available on | MT: available on | MT: available on DL |
| | | DL. | UL. | & UL. |
| | NA | DU: not available; | DU: not available; | DU: not available; |
| | | MT: available on | MT: available on | MT: available on DL |
| | | DL. | UL. | & UL. |

One example of a DU configuration is shown in FIG. 4.

### Frequency-Domain Resource Configuration

In line with time-domain resource coordination between an IAB-MT and co-located IAB-DU through time-domain H/S/NA, frequency-domain resources can also be coordinated through assigning H/S/NA to frequency domain resource blocks (RBs). It may be assumed that:
Hard (H): If a frequency resource is configured as Hard, the IAB-DU may transmit, receive, or either transmit or receive according to its configuration;
Soft(S): If a frequency resource is configured as Soft, the IAB-DU may transmit, receive, or either transmit or receive only if it does not impact the IAB-MT's actual ability to operate in this resource; and
Not-Available (NA): The IAB-DU cannot use the resource.

In accordance with a 3GPP Rel-17 enhanced IAB work item description (WID), the following duplexing enhancements may be specified:
Support of simultaneous operation (transmission and/or reception) of IAB-node's child and parent links (i.e., MT Tx/DU Tx, MT Tx/DU Rx, MT Rx/DU Tx, MT Rx/DU Rx).

The 3GPP Rel-16 IAB specification mainly considers the time-division multiplexing (TDM) case where the IAB-MT and IAB-DU resource of the same IAB-node are separated in time. 3GPP Rel-17 IAB addresses both frequency-division multiplexing (FDM) and spatial-division multiplexing (SDM) resource allocation cases between the IAB-MT and the IAB-DU.

The following was considered regarding frequency domain H/S/NA resource configuration in the recent RAN1 meetings:
RAN1 #105-e
Item: The extension of the semi-static DU resource type indication to frequency-domain resources within a carrier (in addition to existing 3GPP Rel-16 per-carrier granularity) for H/S/NA resource types is supported.
Item: The minimum resource size for configuring the frequency domain granularity is a set of N resource blocks (RBs):
   Candidate values for N: {4, 8, 16, other values to be determined (TBD)};
   N is at least the number of physical resource blocks (PRBs) that are corresponding to the MT's number of PRBs of an RBG); and
   for future study (FFS): Scaling or configuration of N based on system bandwidth (BW) or size of IAB-MT bandwidth part (BWP).
RAN1 #106-e
Item: The semi-static configuration of H/S/NA resource type in frequency domain is provided per RB set, per D/U/F resource type within a slot.
Item: N is a configured number of PRBs, where the CU configures N:
   N= {2, 4, 8, 16, 32, 64};
   FFS: Value(s) of N in case of multiple configured BWPs at the IAB-MT; and
   This does not revert any existing RAN1 agreement.
RAN1 #106bis-e
Item: A single value for the RB set size, N, is configured for a given IAB-DU cell's 3GPP Rel-17 frequency domain H/S/NA configuration.

In cases of simultaneous operation of an IAB-MT and a co-located IAB-DU, frequency-domain resource coordination may be done through partitioning IAB-DU frequency resources and assigning them as H/S/NA. The IAB-DU frequency H/S/NA configuration depends on the overlap of IAB-MT and IAB-DU frequency resources. As considered in RAN1 #106bis-e an IAB-DU may only be configured with one single value, N, for the size of a Resource Block (RB) set, i.e., N RBs per RB set. Since the range of frequency domain resources is not specified, there is ambiguity in the RB set configuration with only the value of N.

### SUMMARY

Some embodiments advantageously provide methods, systems, and apparatuses for resource block (RB) set configuration in an integrated access and backhaul (IAB) network for frequency domain resources.

Methods to efficiently specify the range for the RB sets, and the RB set mapping in the frequency domain (e.g., using RB set indexing), for example, to avoid unnecessary signaling. In addition, the IAB donor-node, parent-node and IAB-node should have a common understanding of the RB set configuration including frequency domain mapping (e.g., indexing).

Some embodiments include a method to configure the IAB-DU RB sets, including frequency domain mapping (e.g., indexing), such that the IAB-donor-node, parent-node and IAB-node can have a common understanding of the mapping between spectrum and RB sets, including complete and incomplete RB sets (which may exist due to IAB-DU carrier bandwidth not being an integer multiple of RB sets), of an IAB-DU cell.

Some embodiments enable an IAB-DU to have a suitable and efficient RB sets configuration, taking IAB-MT BWPs into consideration. Some embodiments also enable the donor-CU and parent-node to efficiently configure and coordinate the frequency domain resource based on the multiplexing condition between an IAB-DU and a co-located IAB-MT. The method is also useful to reduce the signaling overhead of resource configuration.

According to one aspect, a method in a first integrated access and backhaul, IAB, node, the first IAB node including a mobile termination, MT, unit and a distributed unit, DU, includes: receiving an IAB-DU cell and carrier configuration from a second network node, the second network node being one of an IAB donor-CU, and a parent IAB node, the second network node being upstream from the first IAB node. The method also includes reporting resource multiplexing capabilities to the second network node. The method also includes receiving a resource block (RB) set configuration from the second IAB network node, the RB set configuration having an IAB-DU hard/soft/not available H/S/NA, resource configuration, the IAB-DU H/S/NA resource configuration being based at least in part on the resource multiplexing capabilities. The method also includes mapping resource block, RB, sets of the DU based at least in part on the IAB-DU H/S/NA resource configuration and the IAB-DU cell and carrier configuration.

According to this aspect, in some embodiments, the method also includes receiving a BWP configuration from the second network node and mapping the RB sets to the BWPs based in part on the BWP configuration. In some embodiments, the mapping includes allocating a whole number, N, of physical resource blocks, PRBs, to each RB set of a first set of RB sets and, when IAB-DU frequency resources do not encompass all available PRBs, allocating a fraction of the whole number, N, of PRBs to a remaining RB set. In some embodiments, the mapping depends at least in part on whether RB sets of size N can encompass all available RBs, N being an integer greater than 1. In some embodiments, when the RB sets of an IAB-DU H/S/NA resource configuration do not cover an entire carrier bandwidth, the remaining RBs not part of an RB set configuration are considered to be included in a last RB set. In some embodiments, the RB set configuration includes an index that points to a lowest RB of the first IAB-DU cell and carrier configuration. In some embodiments, a starting RB index of the first RB set for the IAB-DU H/S/NA resource configuration is the lowest RB index of the IAB-DU cell. In some embodiments, the IAB-DU cell and carrier configuration is received from the IAB donor-CU and is based at least in part on carriers configured by operations and management, OAM. In some embodiments, the resource multiplexing capabilities for the MT unit and DU of the first IAB node include at least one of an indication of time division multiplexing, TDM, requirements, an indication of frequency division multiplexing, FDM, requirements, and an indication of transmit/receive states of the DU and the MT unit. In some embodiments, the method also includes receiving an RB set configuration from the second network node, the RB set configuration including at least one of an indication of an RB set size, an indication of a mapping method by which the mapping of RB sets is determined, a number of RB sets and an indication of an indexing method by which RB sets are indexed. In some embodiments, the IAB-DU H/S/NA resource configuration includes at least one of a time domain configuration, a frequency domain configuration and an indication of which slots should be time domain multiplexed, TDM, and which slots should be frequency domain multiplexed, FDM. In some embodiments, the method also includes receiving an availability indication for a subset of RB sets that are configured as soft. In some embodiments, the DU of the first IAB node schedules resources based at least in part on the IAB-DU H/S/NA resource configuration. In some embodiments, a maximum number of contiguous and non-overlapping RB sets configurable per cell of the IAB-DU cell and carrier configuration is 8.

According to another aspect, a first integrated access and backhaul, IAB, node, the first IAB node including a mobile termination, MT, unit and a distributed unit, DU, is provided. The first IAB node includes a radio interface configured to: receive an IAB-DU cell and carrier configuration from a second network node, the second network node being one of an IAB donor-CU, and a parent IAB node, the second network node being upstream from the first IAB node. The radio interface is further configured to report resource multiplexing capabilities to the second network node, and receive a resource block, RB, set configuration from the second IAB network node, the RB set configuration having an IAB-DU hard/soft/flexible, H/S/NA, resource configuration, the IAB-DU H/S/NA resource configuration being based at least in part on the resource multiplexing capabilities. The first IAB node also includes processing circuitry in communication with the radio interface and configured to map resource block, RB, sets of the DU, based at least in part on the IAB-DU H/S/NA resource configuration and the IAB-DU cell and carrier configuration.

According to this aspect, in some embodiments, the radio interface is further configured to receive a BWP configuration from the second network node and mapping the RB sets to the BWPs based in part on the BWP configuration. In some embodiments, the mapping includes allocating a whole number, N, of physical resource blocks, PRBs, to each RB set of a first set of RB sets and, when IAB-DU H/S/NA frequency resources do not encompass all available PRBs, allocating a fraction of the whole number, N, of PRBs to a remaining RB set. In some embodiments, the mapping depends at least in part on whether RB sets of size N can encompass all available RBs, N being an integer greater than 1. In some embodiments, when the RB sets of an IAB-DU H/S/NA resource configuration exceed N times a maximum number of M RB sets, the remaining RBs not part of an RB set configuration are considered to be included in a last RB set, N and M being integers greater than zero. In some embodiments, the RB set configuration includes an index that points to a lowest RB of the first IAB-DU cell and carrier configuration. In some embodiments, a starting RB index of the first RB set for the IAB-DU H/S/NA resource configuration is the lowest RB index of the IAB-DU cell. In some embodiments, the IAB-DU cell and carrier configuration is received from the IAB donor-CU and is based at least in part on carriers configured by operations and management, OAM. In some embodiments, the resource multiplexing capabilities for the MT unit and DU of the first IAB node include at least one of an indication of time division multiplexing, TDM, requirements, an indication of frequency division multiplexing, FDM, requirements, and an indication of transmit/receive states of the DU and the MT unit. In some embodiments, the radio interface is further configured to receive an RB set configuration from the second network node, the RB set configuration including at least one of an indication of an RB set size, an indication of a mapping method by which the mapping of RB sets is determined, a number of RB sets and an indication of an indexing method by which RB sets are indexed. In some embodiments, the IAB-DU H/S/NA resource configuration includes at least one of a time domain configuration, a frequency domain configuration and an indication of which slots should be time domain multiplexed, TDM, and which slots should be frequency domain multiplexed, FDM. In some embodiments, the radio interface is further configured to receive an availability indication for a subset of RB sets that are configured as soft. In some embodiments, the DU of the first IAB node schedules resources based at least in part on the IAB-DU H/S/NA resource configuration. In some embodiments, a maximum number of contiguous and non-overlapping RB sets configurable per cell of the IAB-DU cell and carrier configuration is 8.

According to yet another aspect, a method in an integrated access and backhaul, IAB, donor node, the IAB donor node being in communication with a first IAB node, the first IAB node being downstream from the IAB donor node, is provided. The method includes: receiving a resource multiplexing capability from the first IAB node; determining a resource block, RB, set configuration based at least in part on the resource multiplexing capability; determining a DU resource configuration for the first IAB node based at least in part on the RB set configuration; and transmitting the DU resource configuration to the first IAB node.

According to this aspect, in some embodiments, the method further includes, when RB sets of the RB set configuration do not overlap with a BWP, omitting from the DU resource configuration a frequency domain configuration of hard/soft/not applicable, H/S/NA attributes. In some embodiments, the DU resource configuration includes an IAB-DU cell and carrier configuration to the first IAB. In some embodiments, a maximum number of contiguous and non-overlapping RB sets configurable per cell of the IAB-DU cell and carrier configuration is 8. In some embodiments, the RB set configuration including at least one of an indication of an RB set size, a number of RB sets, an indication of a mapping method by which a mapping of RB sets is to be determined by the first IAB node, and an indication of an indexing method by which RB sets are indexed. In some embodiments, transmitting the DU resource configuration to the first IAB node includes transmitting the DU resource configuration via an F1 application protocol, AP.

According to another aspect, an integrated access and backhaul, IAB, donor node, the IAB donor node being in communication with a first IAB node, the first IAB node being downstream from the IAB donor node, is provided. The IAB donor node includes a radio interface configured to receive a resource multiplexing capability from the first IAB node. The IAB donor node also includes processing circuitry in communication with the radio interface and configured to: determine a resource block, RB, set configuration based at least in part on the resource multiplexing capability and determine a DU resource configuration for the first IAB node based at least in part on the RB set configuration. The radio interface is further configured to transmit the DU resource configuration to the first IAB node.

According to this aspect, in some embodiments, when RB sets of the RB set configuration do not overlap with a BWP, the processing circuitry is further configured to omit from the DU resource configuration a frequency domain configuration of hard/soft/not applicable, H/S/NA attributes. In some embodiments, the DU resource configuration includes an IAB-DU cell and carrier configuration to the first IAB. In some embodiments, a maximum number of contiguous and non-overlapping RB sets configurable per cell of the IAB-DU cell and carrier configuration is 8. In some embodiments, the RB set configuration including at least one of an indication of an RB set size, a number of RB sets, an indication of a mapping method by which a mapping of RB sets is to be determined by the first IAB node, and an indication of an indexing method by which RB sets are indexed. In some embodiments, the radio interface is further configured to transmit the DU resource configuration to the first IAB node via an F1 application protocol, AP.

According to yet another aspect, a method in a parent integrated access and backhaul, IAB, node, the parent IAB node being in communication with an IAB donor node and a first IAB node, the IAB parent node being downstream of the IAB donor node and upstream of the first IAB node, is provided. The method includes: activating a mobile termination, MT, unit bandwidth part for the first IAB node; receiving from the IAB donor node a distributed unit, DU, resource configuration for each cell of the first IAB node; receiving from one of the IAB donor node and the first IAB node, a resource block, RB, set configuration for each cell of the first IAB node; and transmitting to the first IAB node an indication of availability of DU resources, the availability of DU resources being based at least in part on the DU resource configuration and the RB set configuration for each cell of the first IAB node.

According to this aspect, in some embodiments, the DU resource configuration for each cell includes at least one hard/soft/not available, H/S/NA, attribute of the DU resource configuration. In some embodiments, the RB set configuration for a cell includes an IAB-DU carrier configuration for the cell. In some embodiments, a maximum number of contiguous and non-overlapping RB sets configurable per cell of the IAB-DU cell and carrier configuration is 8. In some embodiments, the indication of availability of DU resources is transmitted in downlink control information in DCI format 2_5. In some embodiments, the method includes, when the RB sets corresponding to the IAB-DU H/S/NA resource configuration do not cover an entire carrier bandwidth, then considering remaining RBs not part of an RB set configuration to be included in a last RB set.

According to another aspect, a parent integrated access and backhaul, IAB, node, the parent IAB node being in communication with an IAB donor node and a first IAB node, the IAB parent node being downstream of the IAB donor node and upstream of the first IAB node, is provided. The parent IAB node includes processing circuitry configured to activate a mobile termination, MT, unit bandwidth part for the first IAB node. The parent IAB node also includes a radio interface in communication with the processing circuitry and configured to: receive from the IAB donor node a distributed unit, DU, resource configuration for each cell of the first IAB node; receive from one of the IAB donor node and the first IAB node, a resource block, RB, set configuration for each cell of the first IAB node; and transmit to the first IAB node an indication of availability of DU resources, the availability of DU resources being based at least in part on the DU resource configuration and the RB set configuration for each cell of the first IAB node.

According to this aspect, in some embodiments, the DU resource configuration for each cell includes at least one hard/soft/not available, H/S/NA, attribute of the DU resource configuration. In some embodiments, the RB set configuration for a cell includes an IAB-DU carrier configuration for the cell. In some embodiments, a maximum number of contiguous and non-overlapping RB sets configurable per cell of the IAB-DU cell and carrier configuration is 8. In some embodiments, the indication of availability of DU resources is transmitted in downlink control information in DCI format 2_5. In some embodiments, when the RB sets corresponding to the IAB-DU H/S/NA resource configuration do not cover an entire carrier bandwidth, the remaining RBs not part of an RB set configuration are considered to be included in a last RB set.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an IAB deployment that supports multiple hops

FIG. 2 illustrates an upstream parent node and downstream child IAB node of an IAB node together with parent/child backhaul links;

FIG. 3 shows a reference diagram for a two-hop chain of IAB-nodes under an IAB-donor;

FIG. 4 is an example DU configuration;

FIG. 5 is a schematic diagram of an example network architecture illustrating a communication system according to principles disclosed herein;

FIG. 6 is a block diagram of a network node operating as an IAB node that is upstream from a wireless device over a wireless connection according to some embodiments of the present disclosure;

FIG. 7 is a block diagram of the network node of FIG. 6 in communication with an upstream IAB donor node;

FIG. 8 is a flowchart of an example process in a network node for resource block (RB) set configuration in an integrated access and backhaul (IAB) network for frequency domain resources;

FIG. 9 is a flowchart of an example process in a network node for resource block (RB) set configuration in an integrated access and backhaul (IAB) network for frequency domain resources;

FIG. 10 is a flowchart of an example process in a network node for resource block (RB) set configuration in an integrated access and backhaul (IAB) network for frequency domain resources;

FIG. 11 is a flowchart of an example processing in a first IAB node for RB set configuration in an IAB network according to principles disclosed herein;

FIG. 12 is a flowchart of an example processing in an IAB donor node for RB set configuration in an IAB network according to principles disclosed herein;

FIG. 13 is a flowchart of an example processing in a parent IAB node for RB set configuration in an IAB network according to principles disclosed herein;

FIG. 14 is an IAB network;

FIG. 15 is a flowchart of a first example process in an IAB-node;

FIG. 16 is a flowchart of a second example process in an IAB-node;

FIG. 17 is a flowchart of a second example process in an IAB-node; and

FIG. 18 is a first example of mapping BWPs to RBs according to principles disclosed herein;

FIG. 19 is a second example of mapping BWPs to RBs according to principles disclosed herein;

FIG. 20 is a third example of mapping BWPs to RBs according to principles disclosed herein;

FIG. 21 is a fourth example of mapping BWPs to RBs according to principles disclosed herein;

FIG. 22 is a fifth example of mapping BWPs to RBs according to principles disclosed herein;

FIG. 23 is a sixth example of mapping BWPs to RBs according to principles disclosed herein; and

FIG. 24 is a seventh example of mapping BWPs to RBs according to principles disclosed herein.

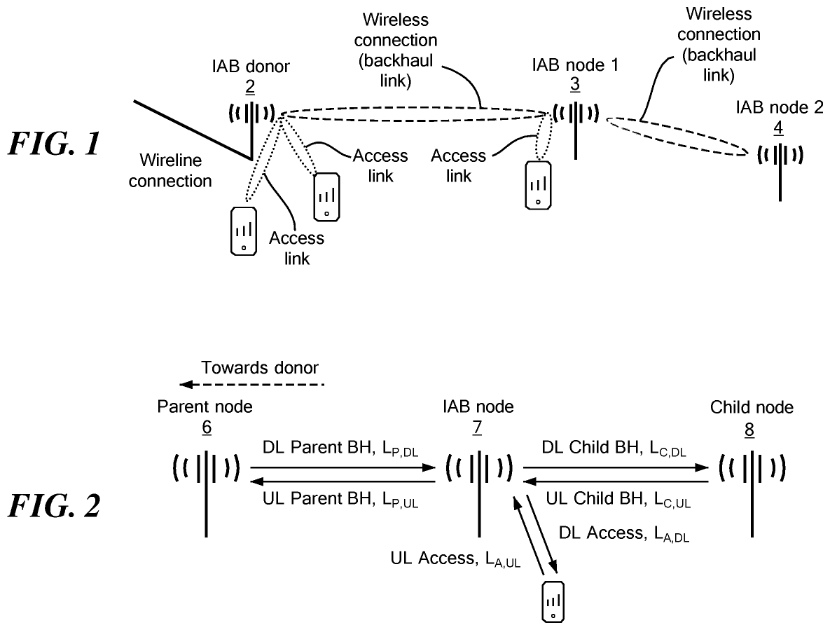

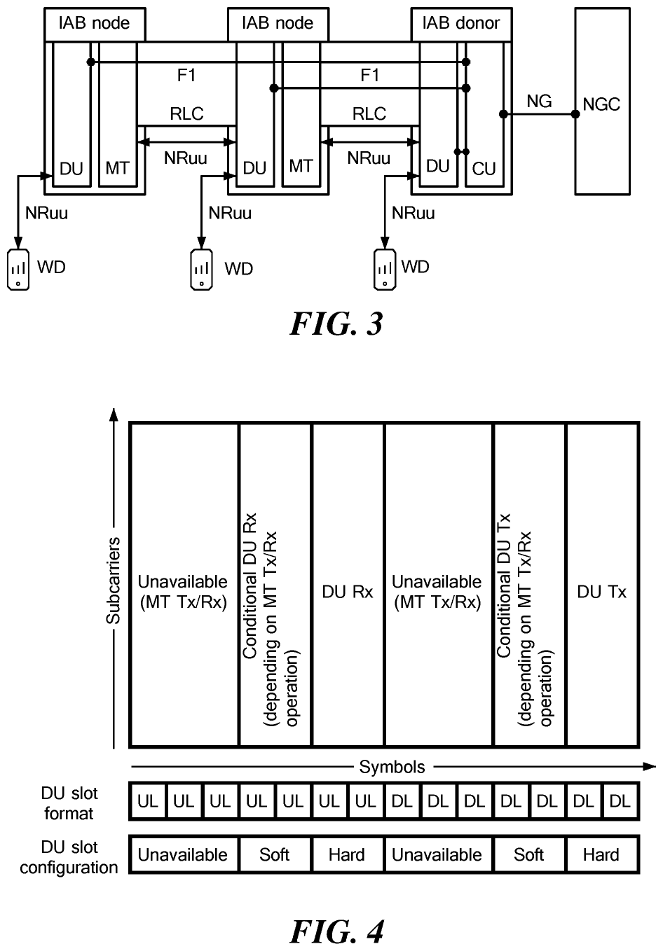

### DETAILED DESCRIPTION

Before describing in detail example embodiments, it is noted that the embodiments reside primarily in combinations of apparatus components and processing steps related to resource block (RB) set configuration in an integrated access and backhaul (IAB) network for frequency domain resources. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node. The term “network node” encompasses an integrated access and backhaul (IAB) donor node, an IAB parent node, and an IAB child node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to resource block (RB) set configuration in an integrated access and backhaul (IAB) network for frequency domain resources

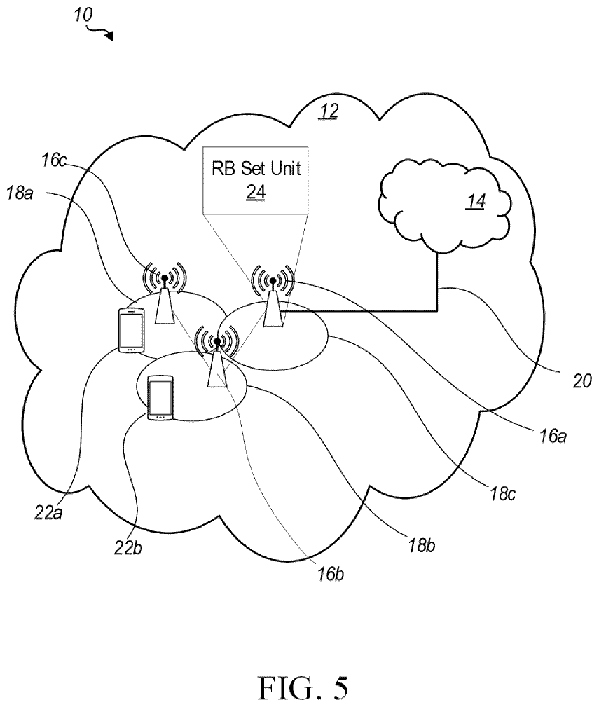

Referring again to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). One or more of network nodes 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

In some embodiments, the network 10 may include an IAB network in which, for example, the network node 16a is a parent IAB node or an IAB donor node, the network node 16b is an IAB node which may be a parent IAB node, and network node 16c or a WD 22 is a child IAB node.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A network node 16 (eNB or gNB) is configured to include an RB set unit 24 which is configured to: configure and/or transmit an RB set configuration. The RB set configuration may be based on a cell and carrier configuration. When the network node 16 is configured as a first IAB node downstream from one of an IAB donor CU and a parent IAB node, the RB set unit 24 may be configured to map RB sets of a distributed unit (DU) of the network node 16 based at least in part on the H/S/NA resource configuration, which is based on the RB set configuration. When the network node 16 is configured as an IAB donor node, the RB set unit 24 may be configured to determine a DU resource configuration for an IAB node based at least in part on the RB set configuration. When the network node 16 is configured as a parent IAB node, the RB set unit 24 may be configured to receive from an IAB donor node and/or another IAB node, the RB set configuration for each cell of the other IAB node.

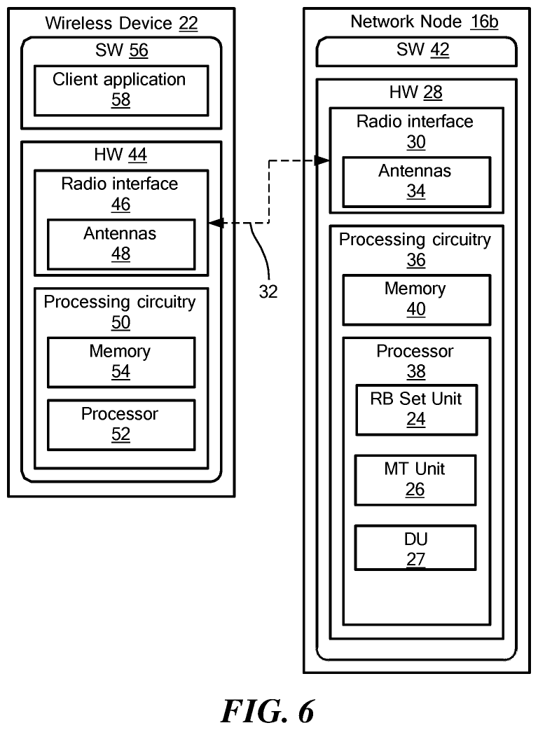

Example implementations, in accordance with an embodiment, of the WD 22 and network node 16 discussed in the preceding paragraphs will now be described with reference to FIG. 6.

The communication system 10 includes a network node 16b provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16b. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16b further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Thus, the network node 16b further has software 42 stored internally in, for example, memory 40, or stored in external memory (e.g., database, storage array, network storage device, etc.) accessible by the network node 16b via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16b functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16b. For example, processing circuitry 36 of the network node 16 may include an RB set unit 24 which is configured to: configure and/or transmit an RB set configuration. The RB set unit 24 may be configured to map RB sets of a distributed unit (DU) of the network node 16b based at least in part on the H/S/NA resource configuration and the cell and carrier configuration of the IAB-DU of the network node 16b. The RB set unit 24 may be configured to receive from an IAB donor node and/or another IAB node, the RB set configuration for each cell of the other IAB node. The network node 16b also includes an MT unit 26 and a DU 27. The communication system 10 further includes the WD 22 already referred to. In some cases, the WD 22 may be considered a child IAB node downstream from its parent IAB node, namely network node 16b. The WD 22 may have hardware 44 that may include a radio interface 46 configured to set up and maintain a wireless connection 32 with a network node 16b serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22.

In some embodiments, the inner workings of the network node 16b and WD 22 may be as shown in FIG. 6 and independently, the surrounding network topology may be that of FIG. 5.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

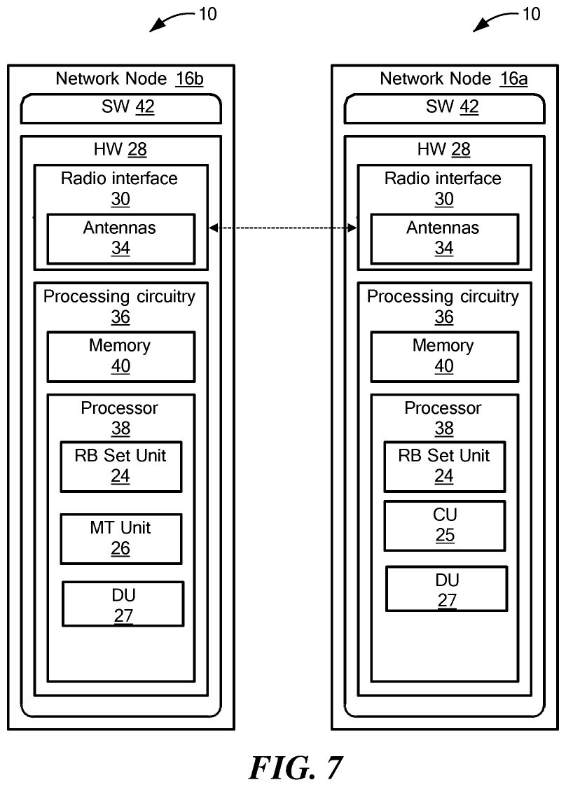

FIG. 7 illustrates the network node 16b downstream from an IAB donor node 16a. Elements of the network node 16b and like-numbered elements of the network node 16a may perform similar functions and operate as described above. However, in an IAB donor node 16a, the RB set unit 24 may be configured to determine a DU resource configuration for the IAB node 16b based at least in part on an RB set configuration. Also, the IAB donor node 16b includes a CU 25.

Although FIGS. 5 and 6 show various “units” such as RB set unit 24 as being within a respective processor, it is contemplated that these units may be implemented such that a portion of the unit is stored in a corresponding memory within the processing circuitry. In other words, the units may be implemented in hardware or in a combination of hardware and software within the processing circuitry.

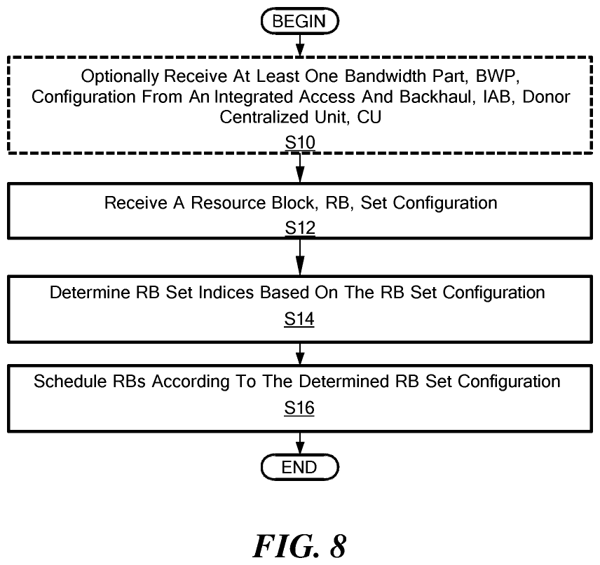

FIG. 8 is a flowchart of an example process in a network node 16 for resource block (RB) set configuration in an integrated access and backhaul (IAB) network for frequency domain resources. One or more blocks described herein may be performed by one or more elements of network node 16 such as by one or more of processing circuitry 36 (including the RB set unit 24), processor 38, and/or radio interface 30. Network node 16 such as via processing circuitry 36 and/or processor 38 and/or radio interface 30 is configured to receive: at least one bandwidth part, BWP, configuration from an integrated access and backhaul, IAB, donor centralized unit, CU (Block S10); and a resource block, RB, set configuration for the at least one BWP, the RB set configuration indicating a number of RB sets and a number of RBs per RB set (Block S12). The process also includes determining RB set indices based on the RB set configuration (Block S14); and scheduling RBs according to the determined RB set configuration (Block S16).

According to this aspect, in some embodiments, the network node 16, processing circuitry 36 and/or radio interface 30 are further configured to: receive an IAB distributed unit, DU, cell/carrier configuration; report a resource multiplexing capability to the donor CU. In some embodiments, an RB set mapping is determined based at least in part on a union of BWPs.

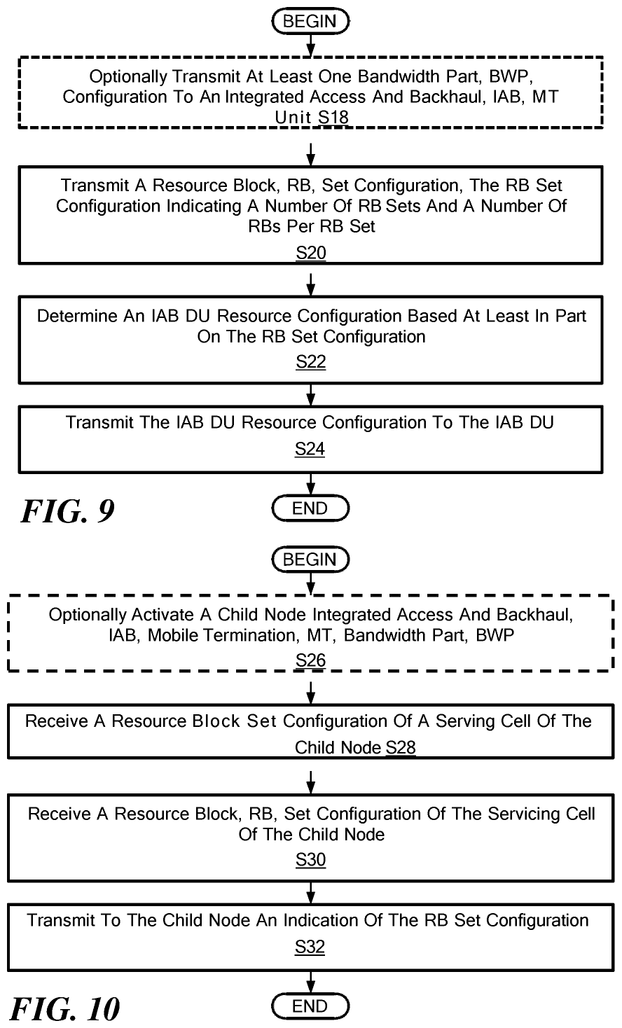

FIG. 9 is a flowchart of an example process in a network node 16 according to some embodiments disclosed herein. One or more blocks described herein may be performed by one or more elements of network node 16 such as by one or more of processing circuitry 36 (including the RB set unit 24), processor 38, and/or radio interface 30. Network node 16 such as via processing circuitry 36 and/or processor 38 and/or radio interface 30 is configured to transmit: at least one bandwidth part, BWP, configuration to an integrated access and backhaul, IAB, MT unit 26 (Block S18). The process also includes transmitting a resource block, RB, set configuration, the RB set configuration indicating a number of RB sets and a number of RBs per RB set (Block S20); determine an IAB DU resource configuration based at least in part on the RB set configuration (Block S22) and transmit the IAB DU resource configuration to the IAB DU (Block S24).

According to this aspect, in some embodiments, the network node 16, when configured as a donor node, processing circuitry 36 and/or radio interface 30 are further configured to transmit an IAB DU cell/carrier configuration to a parent node of the IAB DU. In some embodiments, the RB set configuration indicates a method for determining a range of the RB set configuration.

FIG. 10 is a flowchart of an example process in a network node 16 according to some embodiments disclosed herein. One or more blocks described herein may be performed by one or more elements of network node 16 such as by one or more of processing circuitry 36 (including the RB set unit 24), processor 38, and/or radio interface 30. Network node 16 such as via processing circuitry 36 and/or processor 38 and/or radio interface 30 is configured to activate a child node integrated access and backhaul, IAB, mobile termination, MT, bandwidth part, BWP (Block S26); receive a resource configuration of a serving cell of the child node (Block S28); receive a resource block, RB, set configuration of the serving cell of the child node (Block S30); and transmit to the child node an indication of the RB set configuration (Block S32).

According to this aspect, in some embodiments, the resource configuration includes at least one of a time division duplex, TDD, pattern and a hard/soft/not available, H/S/N, configuration per RB set. In some embodiments, the RB set configuration includes an indication of a size of an RB set and/or a number of RB sets.

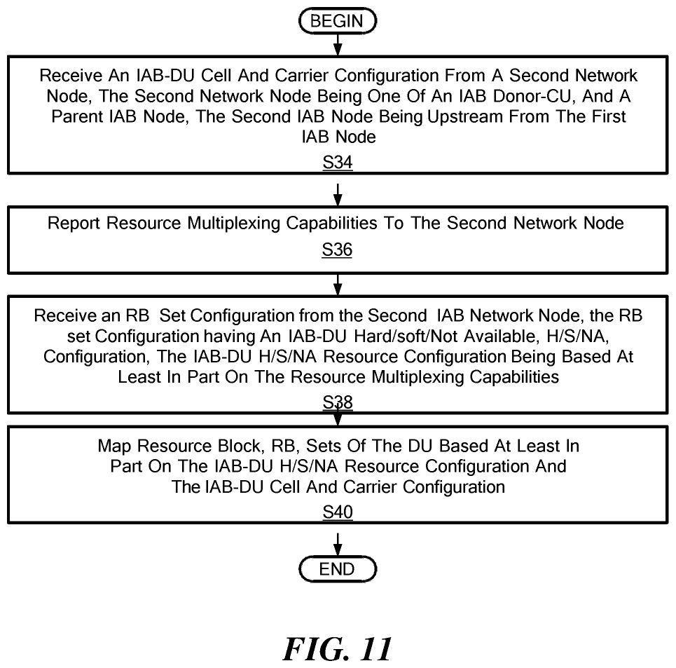

FIG. 11 is a flowchart of an example process in a network node 16 configured as a first IAB node that includes an MT unit and DU, according to some embodiments disclosed herein. One or more blocks described herein may be performed by one or more elements of network node 16 such as by one or more of processing circuitry 36 (including the RB set unit 24, MT unit 26 and the DU 27), processor 38, and/or radio interface 30. Network node 16 such as via processing circuitry 36 and/or processor 38 and/or radio interface 30 is configured to receive an IAB-DU cell and carrier configuration from a second network node, the second network node being one of an IAB donor-CU, and a parent IAB node, the second network node being upstream from the first IAB node (Block S34). The method also includes reporting resource multiplexing capabilities to the second network node (Block S36). The method also includes receiving a resource block, RB, set configuration from the second IAB network node, the RB set configuration having an IAB-DU hard/soft/not available H/S/NA, resource configuration, the IAB-DU H/S/NA resource configuration being based at least in part on the resource multiplexing capabilities (Block S38). The method also includes mapping resource block, RB, sets of the DU based at least in part on the IAB-DU H/S/NA resource configuration and the IAB-DU cell and carrier configuration (Block S40).

According to this aspect, in some embodiments, the method also includes receiving a BWP configuration from the second network node and mapping the RB sets to the BWPs based in part on the BWP configuration. In some embodiments, the mapping includes allocating a whole number, N, of physical resource blocks, PRBs, to each RB set of a first set of RB sets and, when IAB-DU frequency resources do not encompass all available PRBs, allocating a fraction of the whole number, N, of PRBs to a remaining RB set. In some embodiments, the mapping depends at least in part on whether RB sets of size N can encompass all available RBs, N being an integer greater than 1. In some embodiments, when the RB sets of an IAB-DU H/S/NA resource configuration do not cover an entire carrier bandwidth, the remaining RBs not part of an RB set configuration are considered to be included in a last RB set. In some embodiments, the RB set configuration includes an index that points to a lowest RB of the first IAB-DU cell and carrier configuration. In some embodiments, a starting RB index of the first RB set for the IAB-DU H/S/NA resource configuration is the lowest RB index of the IAB-DU cell. In some embodiments, the IAB-DU cell and carrier configuration is received from the IAB donor-CU and is based at least in part on carriers configured by operations and management, OAM. In some embodiments, the resource multiplexing capabilities for the MT unit 26 and DU of the first IAB node include at least one of an indication of time division multiplexing, TDM, requirements, an indication of frequency division multiplexing, FDM, requirements, and an indication of transmit/receive states of the DU and the MT unit 26. In some embodiments, the method also includes receiving an RB set configuration from the second network node, the RB set configuration including at least one of an indication of an RB set size, an indication of a mapping method by which the mapping of RB sets is determined, a number of RB sets and an indication of an indexing method by which RB sets are indexed. In some embodiments, the IAB-DU H/S/NA resource configuration includes at least one of a time domain configuration, a frequency domain configuration and an indication of which slots should be time domain multiplexed, TDM, and which slots should be frequency domain multiplexed, FDM. In some embodiments, the method also includes receiving an availability indication for a subset of RB sets that are configured as soft. In some embodiments, the DU of the first IAB node schedules resources based at least in part on the IAB-DU H/S/NA resource configuration. In some embodiments, a maximum number of contiguous and non-overlapping RB sets configurable per cell of the IAB-DU cell and carrier configuration is 8.

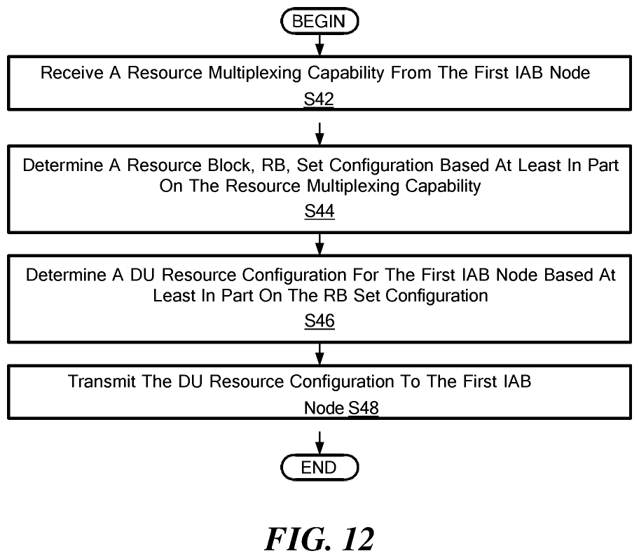

FIG. 12 is a flowchart of an example process in a network node 16 configured as an IAB donor node in communication with a first IAB node, according to some embodiments disclosed herein. One or more blocks described herein may be performed by one or more elements of network node 16 such as by one or more of processing circuitry 36 (including the RB set unit 24, the MT unit 26 and the DU 27), processor 38, and/or radio interface 30. Network node 16 such as via processing circuitry 36 and/or processor 38 and/or radio interface 30 is configured to receive a resource multiplexing capability from the first IAB node (Block S42). The process includes determining a resource block, RB, set configuration based at least in part on the resource multiplexing capability (Block S44). The process also includes determining a DU resource configuration for the first IAB node based at least in part on the RB set configuration (Block S46). The process further include transmitting the DU resource configuration to the first IAB node (Block S48).

According to this aspect, in some embodiments, the method further includes, when RB sets of the RB set configuration do not overlap with a BWP, omitting from the DU resource configuration a frequency domain configuration of hard/soft/not applicable, H/S/NA attributes. In some embodiments, the DU resource configuration includes an IAB-DU cell and carrier configuration to the first IAB. In some embodiments, a maximum number of contiguous and non-overlapping RB sets configurable per cell of the IAB-DU cell and carrier configuration is 8. In some embodiments, the RB set configuration including at least one of an indication of an RB set size, a number of RB sets, an indication of a mapping method by which a mapping of RB sets is to be determined by the first IAB node, and an indication of an indexing method by which RB sets are indexed. In some embodiments, transmitting the DU resource configuration to the first IAB node includes transmitting the DU resource configuration via an F1 application protocol, AP.

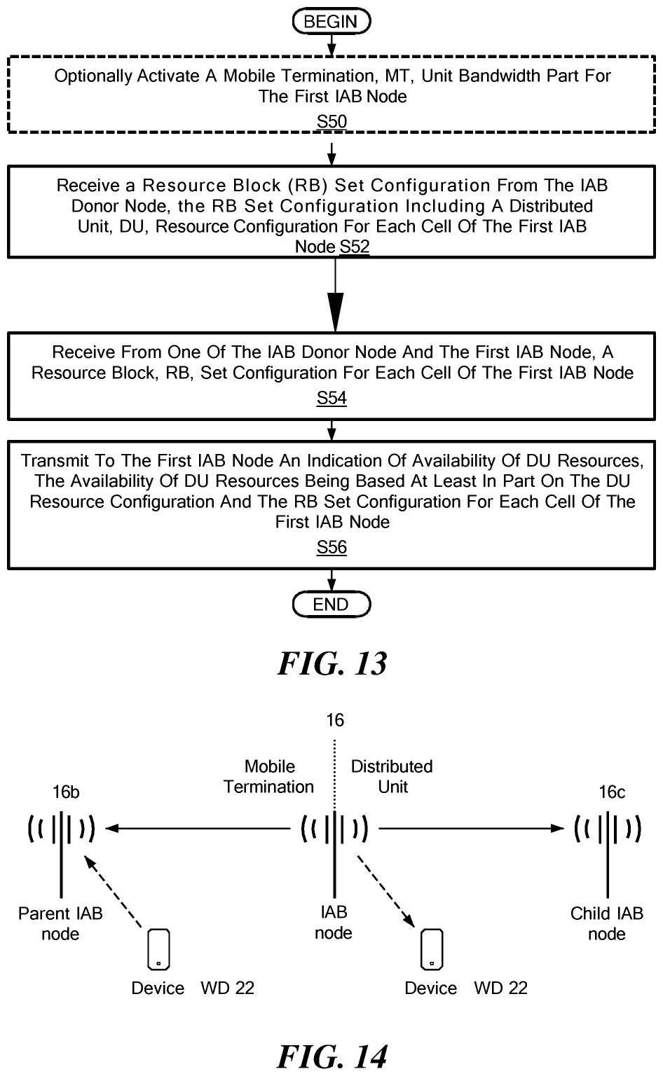

FIG. 13 is a flowchart of an example process in a network node 16 configured as a parent IAB node in communication with an IAB donor node, according to some embodiments disclosed herein. One or more blocks described herein may be performed by one or more elements of network node 16 such as by one or more of processing circuitry 36 (including the RB set unit 24, the MT unit 26 and the DU 27), processor 38, and/or radio interface 30. Network node 16 such as via processing circuitry 36 and/or processor 38 and/or radio interface 30 is configured to activate a mobile termination, MT, unit bandwidth part for the first IAB node (Block S50). The process includes receiving a resource block, RB, set configuration from the IAB donor node, the RB set configuration including a distributed unit, DU, resource configuration for each cell of the first IAB node (Block S52). The method also includes receiving from one of the IAB donor node and the first IAB node, a resource block, RB, set configuration for each cell of the first IAB node (Block S54). The process further includes transmitting to the first IAB node an indication of availability of DU resources, the availability of DU resources being based at least in part on the DU resource configuration and the RB set configuration for each cell of the first IAB node (Block S56).

According to this aspect, in some embodiments, the DU resource configuration for each cell includes at least one hard/soft/not available, H/S/NA, attribute of the DU resource configuration. In some embodiments, the RB set configuration for a cell includes an IAB-DU carrier configuration for the cell. In some embodiments, a maximum number of contiguous and non-overlapping RB sets configurable per cell of the IAB-DU cell and carrier configuration is 8. In some embodiments, the indication of availability of DU resources is transmitted in downlink control information in DCI format 2_5. In some embodiments, the method includes, when the RB sets corresponding to the IAB-DU H/S/NA resource configuration exceed N times a maximum number M of RB sets, considering remaining RBs not part of an RB set configuration to be included in a last RB set, N and M being integers greater than zero.

Having described the general process flow of arrangements of the disclosure and having provided examples of hardware and software arrangements for implementing the processes and functions of the disclosure, the sections below provide details and examples of arrangements for resource block (RB) set configuration in an integrated access and backhaul (IAB) network for frequency domain resources.

An example IAB network is shown in FIG. 14 where an IAB node 16 may be connected downstream from a parent IAB-node 16b and upstream from a device and/or a child IAB node 16c, 22. The parent IAB node 16b may, in turn, also connect a device, or other IAB nodes 16, 22.

### IAB Node Aspect Related to BWPs or DU Carrier Signaling

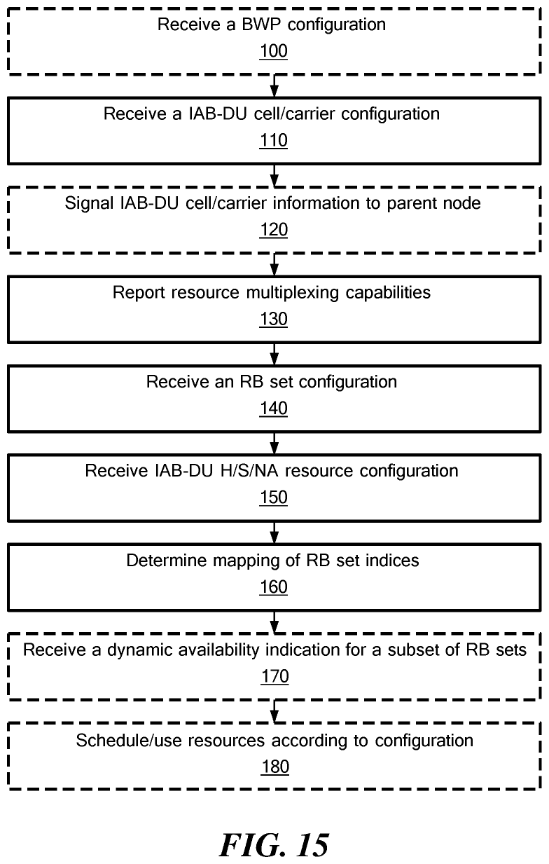

One aspect of some embodiments relates to mapping the RB set indices towards at least one BWP or in the alternative, mapping the RB set indices towards the DU carrier. The mapping may be signaled to other network nodes, e.g., the parent IAB node 16b. Both alternatives are included in FIG. 15 by applying either Step (100) or Step (120), respectively.

Some embodiments include a method in an IAB-node for determining a resource multiplexing configuration between the DU 27 and MT unit 26 parts of the IAB-node 16 based on the RB set configuration information from the IAB donor-CU 16a.

In an optional step (100), the IAB node 16 receives a BWP configuration from another network node, e.g., IAB donor-CU 16 (a) or parent IAB-node (16b). This may be typically received as part of the initial access procedure, e.g., in the parent IAB node's serving cell configuration information from the IAB donor-CU 25 via radio resource control (RRC) signaling. In NR, a BWP configuration may include up to four different BWPs and consequently, the IAB node 16 may receive up to four BWPs as part of a BWP configuration.

In step (110), the IAB node receives a cell and/or carrier configuration from the IAB donor-CU 25 based on carriers configured by operations and management (OAM) to an IAB-DU 27. The IAB node may read such information from a file. The cell and carrier configuration information may be included in IAB-DU serving cell information in SIB1. The approved IAB-DU cells/carriers are activated by the network (e.g., by IAB donor-CU 25); the signaling may be typically handled by RRC and F1 messages. The relevant part of the information include the carrier bandwidth to be used for the IAB-DU cell. The information may also include multiple IAB-DU cells and/or carriers, depending on the IAB node's hardware configuration.

In an optional step (120), the IAB node provides activated IAB-DU cell and/or carrier information to the parent IAB node 16b. Such information may be provided using established signaling, e.g., F1 or medium access control (MAC) control element (CE), etc.

Still referring to FIG. 15, in step (130), the IAB node 16 reports to the donor IAB-node about its resource multiplexing capability for the IAB-DU 27 and the IAB-MT unit 26, which may be one or multiple ones of the following:
TDM required;
TDM not required;
FDM required;
MT TX and DU TX;
MT TX and DU RX;
MT RX and DU TX; and/or.
MT RX and DU RX.

The signaling me be included in an F1 message between IAB donor-CU 25 and IAB-DU 27.

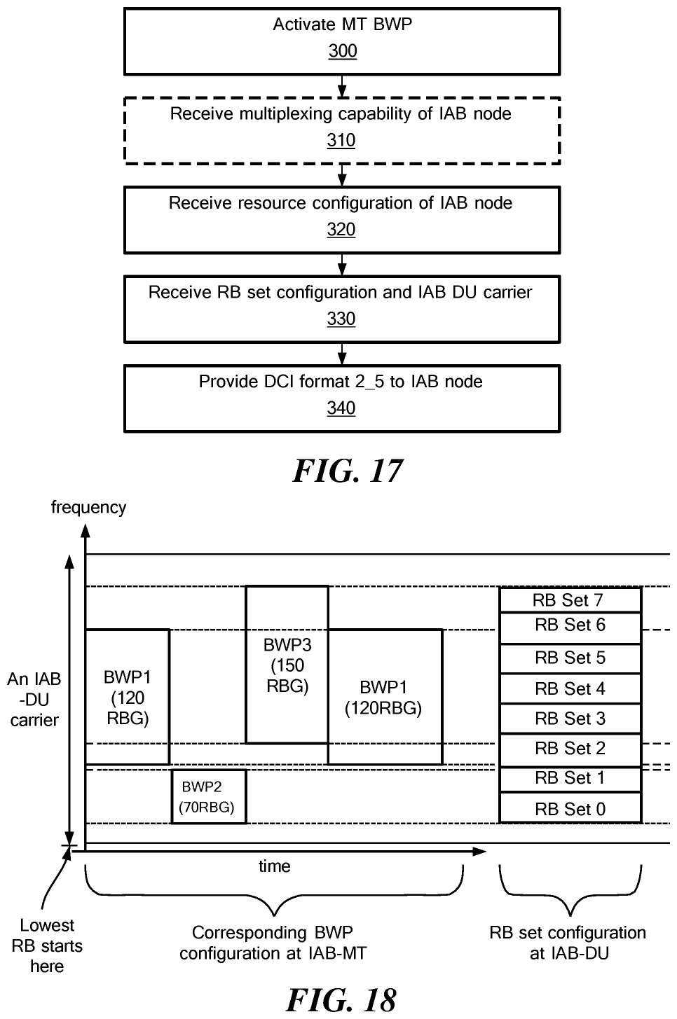

In step (140), the IAB node 16 receives an RB set configuration from the IAB donor-CU 25. The configuration may include one or more of the following:
an indication of the RB set size, i.e., the number of RBs included in an RB set;
an indication of a mapping method between different RB sets and their respective frequency range. In one embodiment, RB sets are mapped with increasing value over the whole DU carrier, starting with the first RB set at the lowest carrier frequency. Depending on the relationship between RB sets and carrier bandwidth, the last RB set may or may not exceed the highest carrier frequency. In one embodiment, the RB sets are mapped contiguously and incrementally in relation to at least one BWP, such that the union of all BWPs constitute the frequency range over which the different RB sets are mapped. Below, multiple examples of such a mapping are provided. See FIGS. 17 and 18, for example; and/or
an indication on the indexing method of the RB sets.

The signaling from the IAB donor-CU 25 may be F1, for example.

In step (150), the IAB node 16 receives a DU H/S/NA configuration. This configuration may be provided for both the time domain and the frequency domain and may also include an indication of what slots should use the time domain multiplexing (TDM) configuration and the frequency domain multiplexing (FDM) configuration, respectively. Alternatively, the TDM/FDM application may be implicitly determined based on a specification from e.g., 3GPP Technical Standard(S) 38.213 [2], or 38.473 [3], etc. The H/S/NA configuration may include indication about what RB sets are to be considered as Hard, Soft and Not Available, respectively, by the DU 27.

In step (160), the IAB node 16 derives a mapping between different RB sets and their respective frequency range based on the received RB set configuration information from step (130).

In an optional step (170), the IAB node 16 receives a dynamic availability indication for a subset of the RB sets which have been configured as Soft. The use of Soft resources by the DU 27, when both RB sets are indicated to be available, and RB sets are not indicated to be available, may be determined by a specification.

In an optional step (180), the DU 27 schedules and use the resources according to its H/S/NA configuration and explicit and implicit availability indications. An implicit indication may be that for a spatial division multiplexing (SDM)-capable IAB node 16, the DU 27 may implicitly use a Soft resource if such use does not have impact on the IAB-MT's operation.

### Donor-Node Related to RB Set Configuration and H/S/NA Configuration

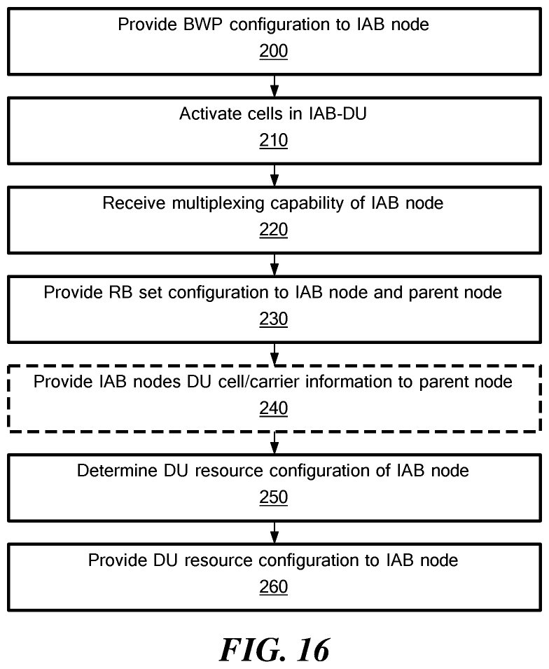

FIG. 16 is a flowchart of an example process related to donor-node embodiments. In step (200), the IAB donor-CU 25 provides the IAB-MT unit 26 with a configuration of the initial BWPs for downlink (DL) and uplink (UL) and additional UL/DL BWPs in a RRC message.

In step (210), the IAB donor-CU 25 actives the IAB-DU cells which are configured by OAM. The signaling between IAB donor-CU 25 and IAB-DU 27 may be, e.g., F1 and RRC etc.

In step (220), the IAB donor-CU 25 receives the IAB-node's multiplexing capability which may be one or multiple one of the following:
TDM required;
TDM not required;
FDM required;
MT TX and DU TX;
MT TX and DU RX;
MT RX and DU TX; and/or.
MT RX and DU RX.

The signaling may be handled by an F1 message between IAB donor-CU 25 and IAB-DU 27.

In step (230), the IAB donor-CU 25 provides the IAB-DU 27 the RB set configuration, including:
an indication of the RB set size, i.e., the number of RBs included in an RB set;
(optionally) an indication of a mapping method between different RB sets and their respective frequency range. In one embodiment, RB sets are mapped contiguously and incrementally over the whole DU carrier, starting with the first RB set at the lowest carrier frequency. Depending on the relationship between RB sets and carrier bandwidth, the last RB set may or may not exceed the highest carrier frequency. In one embodiment, the RB sets are mapped contiguously and incrementally in relation to the at least one BWP, such that the union of all BWPs constitute the frequency range over which the different RB sets are mapped. Below, multiple examples of such a mapping may be provided. See the detailed description of FIGS. 15 and 16;
(optionally) an indication on the indexing method of the RB sets. See the description in reference to FIGS. 15-21.

The signaling from IAB donor-CU 25 to the IAB-DU 27 may be, e.g., via an F1 message.

In an optional step (240), the IAB donor-CU 25 may provide the RB set configuration from step (220) to the parent IAB node 16b, including the carrier information of the IAB-DU cells.

In step (250), the IAB donor-CU 25 determines the DU resource configuration (including the TDD pattern and the H/S/NA attributes) of the IAB-node based on the RB set configuration. In step (260), the IAB donor-CU 25 provides the DU resource configuration (including the TDD patten and the H/S/NA attributes) to the IAB-node based on RB set configuration.

In some embodiments, for RB sets which do not overlap with any IAB-MT BWPs, the IAB donor-CU 25 does not need to provide a configuration of frequency domain H/S/NA and thereby the signaling overhead can be reduced.

### Parent-Node Embodiments Related to RB Set Configuration and Explicit Availability Indication of Soft Resource

FIG. 17 shows a flow chart related to the parent node embodiments.

In step (300) the parent IAB node 16b activates the BWP for IAB-MT unit 26. The signaling may be one of downlink control information (DCI), or medium access control (MAC) control element (CE).

In an optional step (310), the parent IAB node 16b receives the IAB-node's multiplexing capability which may be one or multiple ones of:
TDM required;
TDM not required;
FDM required;
MT TX and DU TX;
MT TX and DU RX;
MT RX and DU TX; and/or.
MT RX and DU RX.

The signaling may be handled by an F1 message between IAB donor-CU 25 and parent IAB-DU 27.

In step (320), the parent IAB node 16b receives the resource configuration of IAB-DU cells, including TDD pattern and H/S/NA attributes. The signaling may be handled by an F1 message between the IAB donor-CU 25 and the parent IAB-DU 27.

In step (330), the parent IAB node 16b receives the RB set configurations of the IAB-DU cells, and the carrier information of the IAB-DU cells. The signaling may be handled by an F1 message between the IAB donor-CU 25 and the parent IAB-DU 27. Alternatively, the signaling may be handled by e.g., MAC CE between the parent IAB node 16b and the IAB-node.

In step (340), the parent IAB node 16b may indicate the explicit availability of IAB-DU resource using DCI format 2_5.

In some embodiments, the parent IAB node 16b may provide DCI format 2_5 (availability indicator for dynamically indicating the availability of the IAB-DU soft frequency resource), based on the RB set indices. In some embodiments, based on the RB set indices, the IAB donor-CU 25 may configure the frequency domain resource related RRC parameters, e.g., AvailabilityCombinationsPerCell, and Availability Indicator etc.

Referring again to FIG. 15, step 140, for a given IAB-DU cell/carrier, the IAB-DU 27 may be configured with a number of Resource Block sets, and the co-located IAB-MT unit 26 may be configured with a number of Bandwidth Parts (BWPs). See FIG. 18, for example. At one time instance, only one IAB-MT BWP is active. Since the IAB-node cannot use an IAB-MT resource that is not included in the configured BWPs, there is no need to coordinate IAB-MT unit 26 and IAB-DU 27 for resources outside the configured BWPs by configuring H/S/NA to the IAB-DU 27. Some embodiments determine the range of the RB sets, (and accordingly, the number of RB sets) in the IAB-DU cell by considering the union of the configured IAB-MT BWPs and the value N (i.e., the number of PRBs in an RB set). With this method, an IAB-DU resource that is not mapped to a certain RB set will not receive an H/S/NA configuration. Since the configured BWPs are known to the parent-node, the parent IAB node 16b will know about the configured RB sets at the IAB-DU 27 without additional information about the carrier of the IAB-DU cell. As depicted in FIG. 18, this may result in at least one incomplete RB set which has less than N RBs. See RB set 7 in FIG. 18.

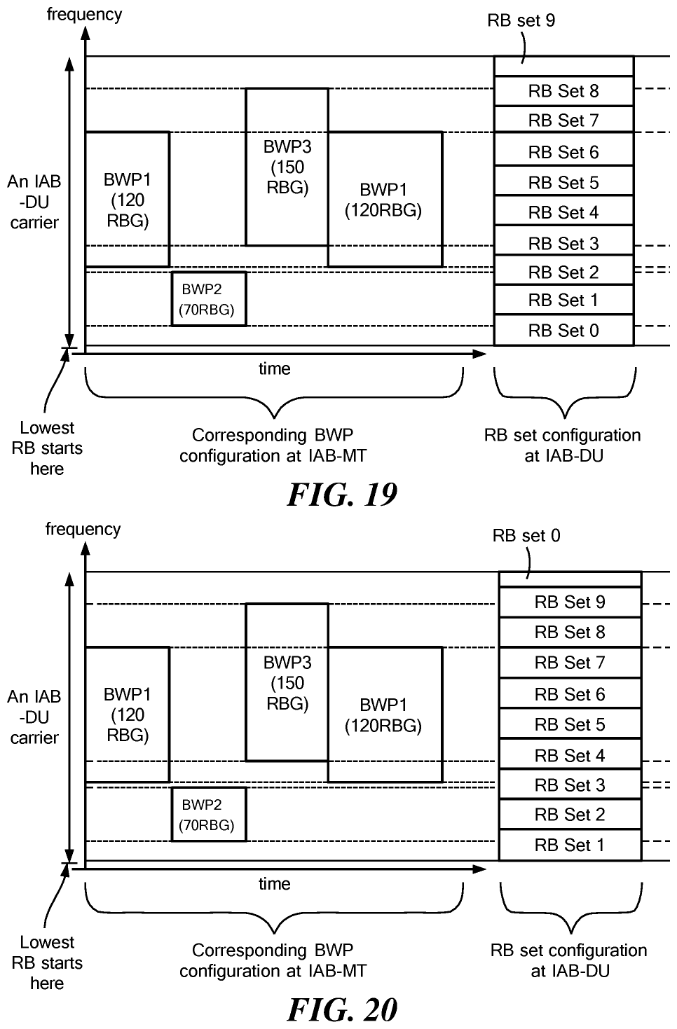

FIG. 19 is an example of one alternative way to configure RB sets where the number of RB sets in the IAB-DU cell may be determined by the size of the IAB-DU cell/carrier (i.e., the entire IAB DU cell) and the value N. This method could also result in incomplete RB set(s) which have less than N RBs. With this method, IAB-DU resource will always be mapped to a certain RB set. In order for the parent IAB node 16b to know about the configured RB sets at the IAB-DU 27, the information about the IAB-DU carrier should be provided to the parent IAB node 16b.

RB set frequency domain mapping (i.e., RB set indexing) aspect (step 140): There are different ways to map the frequency domain resource to the multiple RB sets at IAB-DU 27, referred to as RB set indexing, depending on how the incomplete RB set(s) is specified. Below are some examples, assuming there are totally M RB sets configured to the IAB-DU cell.

### Type-A Indexing

FIGS. 18 and 19 provide two examples of Type-A indexing. In FIG. 19, starting from the lowest RB of the IAB-DU carrier, the indexing of RB sets begins with RB set 0, RB set 1 and so on. The numbering continues to the last RB set M, i.e., RB set 9 in FIG. 19. The first M-1 RB sets are complete RB sets, whereas the last RB set, i.e., the RB set with the highest index, may be an incomplete RB set, i.e., consisting of less than N RBs.

### Type-B Indexing

FIG. 20 provides an example of Type-B indexing. Starting from the lowest RB of the IAB-DU carrier, the indexing of RB sets begins with RB set 1, RB set 2 and so on. The numbering continues to the next last RB set M-1, i.e., RB set 9 in the figure. The first M-1 RB sets are complete RB sets, whereas the last RB set may be an incomplete RB set, i.e., consisting of less than N RBs. The last (potentially incomplete) RB set has always index 0.

### Type-C Indexing

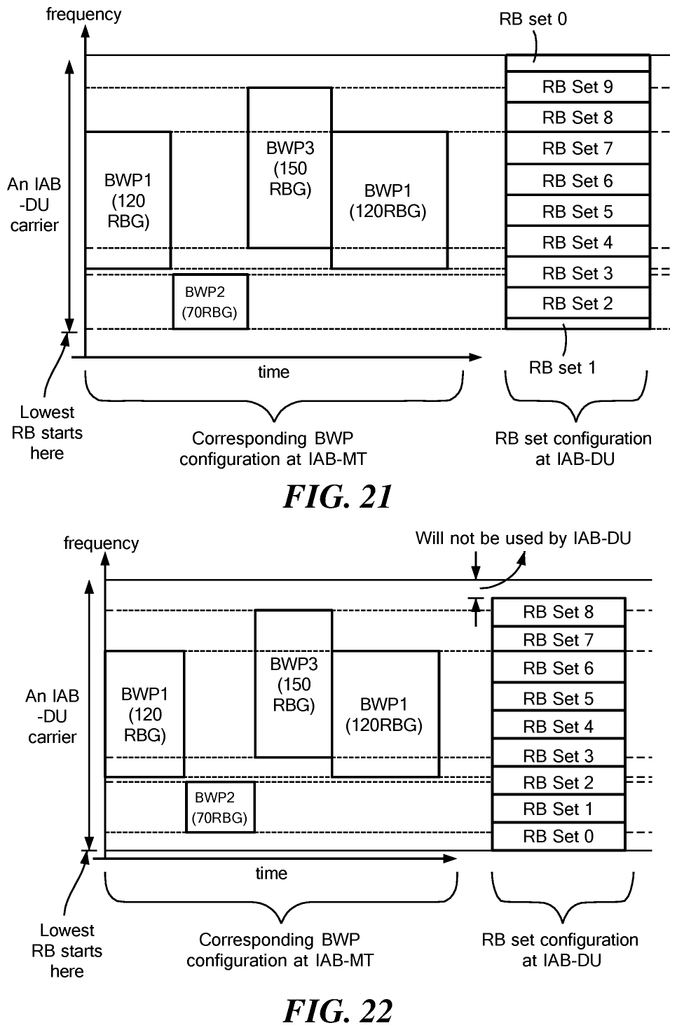

FIG. 21 provides an example of Type-C indexing. Starting from the lowest RB of the IAB-DU carrier, the indexing of RB sets begins with RB set 1, RB set 2 and so on. The numbering continues until RB set M-1, i.e., RB set 9 in the figure. The last RB set has always index 0. Both the first RB set (RB set 1) and the last RB set (RB set 0) may be incomplete RB set(s). All other RB sets (RB set 2 to RB set M-1) are complete RB sets.

### Type-D Indexing

FIG. 22 illustrates a method for only indexing complete RB sets. Starting from the lowest RB of the IAB-DU carrier, the indexing of RB sets begins with RB set 0, RB set 1 and so on. The numbering continues to the last complete RB set M-1, i.e., RB set 8 in FIG. 22.

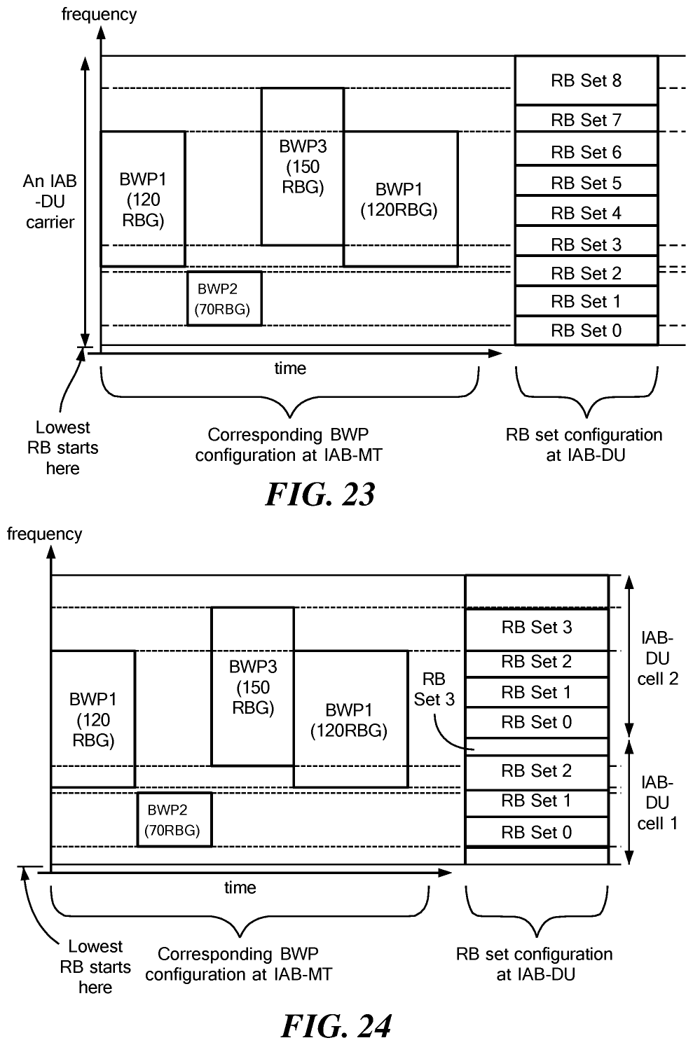

In one embodiment, the incomplete RB set may be merged with the adjacent RB set such that the combined RB set may be a larger RB set. Alternatively, comparison to a threshold may determine if the incomplete RB set should be merged or assigned an independent index. Alternatively, the incomplete RB set is not used, either by the MT unit 26 or the IAB DU 27. FIG. 22 provides another example of Type-D indexing, where the incomplete RB set may be merged to the adjacent complete set, i.e., the RB set 8 in FIG. 23, and becomes an extend RB set which has more than N RBs. In an alternative embodiment, the extended RB set (i.e., has more than N RBs) could have index 0.

In some embodiments, a fixed RB set indexing may be applied to an IAB-DU cell and it may be one of Type-A, or Type-B, or Type-C, or Type-D mapping methods.

In some embodiments, the indexing of RB sets may be changed. The determination of which type of indexing (type-A/type-B/type-C/type-D) should be applied to the IAB-DU cell may be performed at the IAB donor-CU 25 and the activation signaling to inform the IAB-DU 27 about the selected type could be, e.g., F1 or RRC, etc. In some embodiments, the proposed methods may be extended to the case when the IAB-MT unit 26 serving cell (configured with multiple IAB-MT BWPs) overlaps in the frequency domain with multiple IAB-DU cells. FIG. 24 shows an example when the IAB-MT serving cell (configured with multiple IAB-MT BWPs) overlaps in the frequency domain with two IAB-DU cells. The RB set configuration may still be determined by the union of the configured IAB-MT

BWPs which overlaps with each IAB-DU frequency resource.

Some embodiments may include some or all of the following:

### IAB Node Multi-BWP Aspect:

A method in an IAB node 16 for resource multiplexing configuration between its DU 27 and MT 26 parts, the method comprising:
a. Receiving at least one BWP configuration from a network node (e.g., donor-CU 25);
b. Receiving an IAB-DU cell/carrier configuration;
c. Reporting resource multiplexing capability to donor-CU 25;
d. Receiving an RB set configuration for the at least one received BWP, including an indication of the number of RBs per RB set (value N) and/or the number of RB sets;
e. Receiving an IAB-DU resource configuration including H/S/NA configuration based on the RB set configuration;
f. determining RB set indices (or an RB set mapping) based on the RB set configuration;
g. (optionally) receive a dynamic availability indication for a subset of RB sets; and/or
h. Scheduling/using resources according to the determined configuration

2. All the above and where the RB set mapping is determined from the union of the at least one BWP.

### IAB-Node DU Carrier Signaling Aspect

A method in an IAB node 16 for resource multiplexing configuration between its DU and MT parts, the method comprising;
a. Receiving an IAB-DU cell/carrier configuration;
b. (Optionally) Signaling the IAB-DU cell/carrier configuration to the parent node 16b;
c. Reporting the resource multiplexing capability to donor-CU 25;
d. Receiving an RB set configuration, including an indication of the size of an RB set and (optionally) an indication on RB set mapping/indexing method;
e. Receiving an IAB-DU resource configuration including H/S/NA configuration based on RB set configuration;
f. Determining RB set indices (or an RB set mapping) based on the RB set configuration; and/or
g. Scheduling/using resources according to the determined configuration IAB Donor-node aspect.

A method in a network node to provide RB set configuration and resource configuration to an IAB-node 16 for resource multiplexing configuration between IAB-DU and IAB-MT parts, the method comprising;
a. Provide configurations of BWPs to the IAB-node 16;
b. Activating the IAB-DU cells based on the OAM configuration;
C. Receiving at least one multiplexing capability from the IAB-node 16
d. Provide RB set configuration to the IAB node 16, including:
   i. An indication of a size of an RB set (value N);
   ii. (optionally) an indication of how to determine the RB sets configuration range (e.g., BWP-based or carrier-based);
   iii. (optionally) an indication on RB set mapping/indexing method;
e. (optionally) Signaling the IAB-DU cell/carrier configuration to the IAB-node's parent node 16b;
f. Determining an IAB-DU resource configuration including H/S/NA configuration based on the RB set configuration; and/or
g. Signaling the IAB-DU resource configuration to the IAB-node

### IAB Parent-Node Aspect.

A method in an IAB node 16 for explicit availability indication of the child IAB-DU soft resource, the method comprising:
a. Activating child IAB-MT BWP;
b. (optionally) receiving resource multiplexing capability regarding (child) IAB-DU 27 and IAB-MT unit 26;
c. Receiving a resource configuration of the (child) IAB-DU serving cell, includes at least:
   i. TDD pattern; and
   ii. H/S/NA configuration per RB set;
d. Receiving RB set configuration of the child IAB-DU serving cell, includes at least:
   i. (optionally) the DU cell/carrier configuration;
   ii. indication of an RB set size;
   iii. (optionally) an indication of RB set indexing method (e.g., RB set frequency domain mapping); and/or
   iv. (optionally) an indication of RB set range (e.g., BWP-based or carrier-based).
e. Providing to the child IAB-node DCI format 2_5 for explicit availability indication of IAB-DU RB sets, e.g., based on:
   i. The child IAB-MT BWP configuration;
   ii. The child IAB-DU resource configuration.
   Some embodiments may include one or more of the following:

Embodiment A1. A network node 16 configured to, and/or comprising a radio interface and/or comprising processing circuitry configured to:
receive:
   at least one bandwidth part, BWP, configuration from an integrated access and backhaul, IAB, donor centralized unit, CU 25; and
   a resource block, RB, set configuration for the at least one BWP, the RB set configuration indicating a number of RB sets and a number of RBs per RB set;
determine RB set indices based on the RB set configuration; and
schedule RBs according to the determined RB set configuration.

Embodiment A2. The network node 16 of Embodiment A1, wherein the network node 16, processing circuitry 36 and/or radio interface 30 are further configured to:
receive and IAB distributed unit, DU, cell/carrier configuration;
report a resource multiplexing capability to the donor CU 25.

Embodiment A3. The network node 16 of any of Embodiments A1 and A2, wherein a RB set mapping is determined based at least in part on a union of BWPs.

Embodiment B1. A method implemented in a network node 16, the method comprising:
receiving:
   at least one bandwidth part, BWP, configuration from an integrated access and backhaul, IAB, donor centralized unit, CU 25; and
   a resource block, RB, set configuration for the at least one BWP, the RB set configuration indicating a number of RB sets and a number of RBs per RB set;
   determining RB set indices based on the RB set configuration; and
   scheduling RBs according to the determined RB set configuration.

Embodiment B2. The method of Embodiment B1, further comprising:
receiving and IAB distributed unit, DU, cell/carrier configuration; and
reporting a resource multiplexing capability to the donor CU 25.

Embodiment B3. The method of any of Embodiments B1 and B2, wherein a RB set mapping is determined based at least in part on a union of BWPs.

Embodiment C1. A network node 16 configured to, and/or comprising a radio interface 30 and/or comprising processing circuitry 36 configured to:
transmit:
   at least one bandwidth part, BWP, configuration to an integrated access and backhaul, IAB, distributed unit, DU 27; and
   a resource block, RB, set configuration for the at least one BWP, the RB set configuration indicating a number of RB sets and a number of RBs per RB set; and
determine an IAB DU resource configuration based at least in part on the RB set configuration; and
transmit the IAB DU resource configuration to the IAB DU 27.

Embodiment C2: The network node 16 of Embodiment C1, wherein the network node 16, processing circuitry 36 and/or radio interface 30 are further configured to transmit an IAB DU cell/carrier configuration to a parent node 16b of the IAB DU.

Embodiment C3. The network node of any of Embodiments C1 and C2, wherein the RB set configuration indicates a method for determining a range of the RB set configuration.

Embodiment D1. A method implemented in a network node 16, the method comprising:
transmitting:
   at least one bandwidth part, BWP, configuration to an integrated access and backhaul, IAB, distributed unit, DU 27; and
   a resource block, RB, set configuration for the at least one BWP, the RB set configuration indicating a number of RB sets and a number of RBs per RB set; and
determining an IAB DU resource configuration based at least in part on the RB set configuration; and
transmitting the IAB DU resource configuration to the IAB DU 27.

Embodiment D2: The method of Embodiment D1, wherein the network node, processing circuitry and/or radio interface are further configured to transmit an IAB DU cell/carrier configuration to a parent node of the IAB DU 27.

Embodiment D3. The method of any of Embodiments D1 and D2, wherein the RB set configuration indicates a method for determining a range of the RB set configuration.

Embodiment E1: A network node 16 configured to, and/or comprising a radio interface 30 and/or comprising processing circuitry 36 configured to:
activate a child node integrated access and backhaul, IAB, mobile termination, MT 26, bandwidth part, BWP;
receive a resource configuration of a serving cell of the child IAB node 16c, 22;
receive a resource block, RB, set configuration of the servicing cell of the child IAB node 16c, 22; and
transmit to the child node an indication of the RB set configuration.

Embodiment E2. The network node of Embodiment E1, wherein the resource configuration includes at least one of a time division duplex, TDD, pattern and a hard/soft/not available, H/S/N, configuration per RB set.

Embodiment E3. The network node of any of Embodiments E1 and E2, wherein the RB set configuration includes an indication of a size of a RB set.

Embodiment F1. A method implemented in a network node 16, the method comprising:
activating a child node integrated access and backhaul, IAB, mobile termination, MT 26, bandwidth part, BWP;
receiving a resource configuration of a serving cell of the child IAB node 16c;
receiving a resource block, RB, set configuration of the servicing cell of the child IAB node 16c; and
transmitting to the child IAB node 16c an indication of the RB set configuration.

Embodiment F2. The method of Embodiment F1, wherein the resource configuration includes at least one of a time division duplex, TDD, pattern and a hard/soft/not available, H/S/N, configuration per RB set.

Embodiment F3. The method of any of Embodiments F1 and F2, wherein the RB set configuration includes an indication of a size of a RB set.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a first integrated access and backhaul, IAB, node, the first IAB node including a mobile termination, MT, unit and a distributed unit, DU, the method comprising:
receiving an IAB-DU cell and carrier configuration from a second network node, the second network node being one of an IAB donor centralized unit, and a parent IAB node, the second network node being upstream from the first IAB node;
reporting resource multiplexing capabilities to the second network node;
receiving a resource block, RB, set configuration from the second IAB network node, the RB set configuration having an IAB-DU hard/soft/not available, H/S/NA, resource configuration, the IAB-DU H/S/NA resource configuration being based at least in part on the resource multiplexing capabilities; and
mapping resource block, RB, sets of the DU based at least in part on the IAB-DU H/S/NA resource configuration and the IAB-DU cell and carrier configuration.

2. The method of claim 1, further comprising receiving a BWP configuration from the second network node and mapping the RB sets to the BWPs based in part on the BWP configuration.

3. The method of claim 2, wherein the mapping includes allocating a whole number, N, of physical resource blocks, PRBs, to each RB set of a first set of RB sets and, when IAB-DU frequency resources do not encompass all available PRBs, allocating a fraction of the whole number, N, of PRBs to a remaining RB set.

4. The method of claim 3, wherein the mapping depends at least in part on whether RB sets of size N can encompass all available RBs, N being an integer greater than 1.

5. The method of claim 1, wherein, when the RB sets of an IAB-DU H/S/NA resource configuration exceed N times a maximum number M of RB sets, the remaining RBs not part of an RB set configuration are considered to be included in a last RB set, N and M being integers greater than zero.

6. The method of claim 1, wherein the RB set configuration includes an index that points to a lowest RB of the first IAB-DU cell and carrier configuration.

7. The method of claim 1, wherein a starting RB index of the first RB set for the IAB-DU H/S/NA resource configuration is the lowest RB index of the IAB-DU cell.

8. The method of claim 1, wherein the IAB-DU cell and carrier configuration is received from the IAB donor-CU and is based at least in part on carriers configured by operations and management, OAM.

9. The method of claim 1, wherein the resource multiplexing capabilities for the MT unit and DU of the first IAB node include at least one of an indication of time division multiplexing, TDM, requirements, an indication of frequency division multiplexing, FDM, requirements, and an indication of transmit/receive states of the DU and the MT unit.

10. The method of claim 1, further comprising receiving an RB set configuration from the second network node, the RB set configuration including at least one of an indication of an RB set size, an indication of a mapping method by which the mapping of RB sets is determined, a number of RB sets and an indication of an indexing method by which RB sets are indexed.

11. The method of claim 1, wherein the IAB-DU H/S/NA resource configuration includes at least one of a time domain configuration, a frequency domain configuration and an indication of which slots should be time domain multiplexed, TDM, and which slots should be frequency domain multiplexed, FDM.

12. The method of claim 1, further comprising receiving an availability indication for a subset of RB sets that are configured as soft.

13. The method of claim 1, wherein the DU of the first IAB node schedules resources based at least in part on the IAB-DU H/S/NA resource configuration.

14. The method of claim 1, wherein a maximum number of contiguous and non-overlapping RB sets configurable per cell of the IAB-DU cell and carrier configuration is 8.

15. A first integrated access and backhaul, IAB, node, the first IAB node including a mobile termination, MT, unit and a distributed unit, DU, the first IAB node comprising:
a radio interface configured to:
receive an IAB-DU cell and carrier configuration from a second network node, the second network node being one of an IAB donor centralized unit, and a parent IAB node, the second network node being upstream from the first IAB node;
report resource multiplexing capabilities to the second network node; and
receive a resource block, RB, set configuration from the second IAB network node, the RB set configuration having an IAB-DU hard/soft/flexible, H/S/NA resource configuration, the IAB-DU H/S/NA resource configuration being based at least in part on the resource multiplexing capabilities; and
processing circuitry in communication with the radio interface and configured to map resource block, RB, sets of the DU, based at least in part on the IAB-DU H/S/NA resource configuration and the IAB-DU cell and carrier configuration.

16.-28. (canceled)

29. A method in an integrated access and backhaul, IAB, donor node, the IAB donor node being in communication with a first IAB node, the first IAB node being downstream from the IAB donor node, the method comprising:
receiving a resource multiplexing capability from the first IAB node;
determining a resource block, RB, set configuration based at least in part on the resource multiplexing capability;
determining a DU resource configuration for the first IAB node based at least in part on the RB set configuration; and
transmitting the DU resource configuration to the first IAB node.

30. The method of claim 29, further comprising, when RB sets of the RB set configuration do not overlap with a BWP, omitting from the DU resource configuration a frequency domain configuration of hard/soft/not applicable, H/S/NA attributes.

31. The method of claim 29, wherein the DU resource configuration includes an IAB-DU cell and carrier configuration to the first IAB node.

32. The method of claim 29, wherein a maximum number of contiguous and non-overlapping RB sets configurable per cell of the IAB-DU cell and carrier configuration is 8.

33. The method of claim 29, wherein the RB set configuration including at least one of an indication of an RB set size, a number of RB sets, an indication of a mapping method by which a mapping of RB sets is to be determined by the first IAB node, and an indication of an indexing method by which RB sets are indexed.

34. The method of claim 29, wherein transmitting the DU resource configuration to the first IAB node includes transmitting the DU resource configuration via an F1 application protocol, AP.

35.-52. (canceled)
